(19) United States
(12) Patent Application Publication
(10) Pub. No.: US 2018/0032128 A1
(43) Pub. Date: Feb. 1, 2018

(54) Cognitive Navigation and Manipulation (CogiNav) Method

(71) Applicant: MISTEMS Innovation and Services Ltd., Gyor (HU)

(72) Inventors: Péter Baranyi, Budaors (HU); Péter Galambos, Herceghalom (HU); Ádám Csapó, Budapest (HU); László Jaloveczki, Budapest (HU)

(21) Appl. No.: 15/658,579

(22) Filed: Jul. 25, 2017

Related U.S. Application Data
(60) Provisional application No. 62/366,656, filed on Jul. 26, 2016.

(51) Int. Cl. G06F 3/01; G06T 15/20; G06F 3/0354; G06F 3/0488; G06F 3/0489; G06F 1/16; G06F 3/0481; G06T 19/00

(52) U.S. Cl. CPC G06F 3/012; G06F 3/04815; G06T 15/205; G06T 19/006; G06F 3/017; G06F 3/0488; G06F 3/0489; G06F 1/163; G06F 3/03543

(57) ABSTRACT

It is a common desire for users of spatial computer environments (both in VR and AR) to be able to navigate in space and manipulate objects in much the same way as they are used to in physical reality. However, due to the large degrees of freedom of this problem, existing solutions operate either by restricting the number of operations that can be performed, or by proposing overly complicated solutions. Cognitive Navigation and Manipulation introduces a context dependent solution for navigation and object translation/rotation in VR, allowing users to perform operations in an intuitive way, even with only a very simple input device at their disposal. The device is required to have no more than 3 buttons and 3 continuous input dimensions.

### TECHNICAL FIELD

The invention relates to a method for representing functional behaviors relevant to navigation in a computer generated or computer augmented spatial environment, as well as functional behaviors relevant to the translation, rotation and position-relative circumnavigation of 2D and 3D object representations within said computer generated or computer augmented spatial environment; using a minimum of one computing device, one display device and one input device.

The method disclosed herein pertains to the field of virtual and augmented reality, more generally to the area of spatial operating systems.

### BACKGROUND OF THE INVENTION

It is a common desire for users of spatial computer environments (both in VR and AR) to be able to navigate in space and manipulate objects in much the same way as they are used to in physical reality. However, the devices that are used to communicate this desire to the 3D virtual space are severely limited in their communication capabilities (there are simply too few buttons, and in general too few degrees of freedom). A complete solution to this problem would enable users to transfer their complete physical embodiment into the virtual space, but achieving this will be difficult in the near future. A better alternative is to increase the intelligence of the virtual space, allowing users to communicate with it more at the level of intentions that at the low level of input signals.

### SUMMARY

The present invention, namely the CogiNav technology solves the problem of seamless navigation and manipulation in 3D virtual space using a generic input device model that includes:
2+1 continuous input dimensions (although any device in general can be used, the first two dimensions correspond to the left-right forward-back mouse movements, while the third one corresponds to the mouse scrollbar, which can be rolled forward and backward). The three dimensions are referred to in the text as DimensionX, DimensionY and the Scroll, respectively, in the text.
3 buttons. The three buttons are referred to as Button1, Button2 and Button3, respectively, in the text.

The CogiNav technology operates by taking; into consideration the context of the camera (or more generally, the avatar) and the object that it is looking at, using those two pieces of information to deduce the intentions of the user, and finally mapping those intentions onto the limited degrees of freedom of the input device and the characteristics of the camera movements. Thus, although the input dimensions of the input device are limited, their function changes through context in a way that fits naturally with users' expectations from the physical world. The terms used in the description of the cognitive navigation and manipulation method are shown in FIG. 1:

The key features and benefits of the invention are:

Navigating in 3D space and moving/rotating objects is a constant source of frustration even in state-of-the-art 3D graphical systems. As discussed earlier, a key problem is that users are unable to transfer into the virtual space their natural expectations of being able to look down and rotate their head to the left and right, and of viewing the horizon at a horizontal perspective once looking back up. Another key problem is that it is nearly impossible to define objects as points of reference around which users can perform movement and rotation operations.

The general objective of the present application is that all of these problems can be solved with an input device that has three continuous input dimensions and three buttons.

### BRIEF DESCRIPTION OF THE DRAWINGS

FIG. 1. Shows the conceptual layout of the input device. The actuators shown on the figure can be in any arrangement, the only requirement is that DimensionX, DimensionY and Scroll provide continuous input values, while Button1, Button2 and Button3 provide discrete input events.

FIG. 2: Demonstrates the passive cognitive solution to the problem of keeping the view horizontal following yaw rotations.

FIG. 3: Provides a schematic view of the spherical orbit, which allows users to move around an object while maintaining distance from it and a constant view of it.

FIG. 4. Shows that hovering operations cause the camera's Zc coordinate to be fixed, allowing the user to keep a fixed distance from the scene while making translational movements in the Xc-Yc coordinate system.

FIG. 5: Shows that the velocity of navigation is normally directly proportional to the distance of the object that is focused on (the object that is at the center of the screen, pointed at by axis-Zc).

FIG. 6: Shows that the default plane for translation is selected based on the angle between the normal vectors of key planes defining the 3-dimensional local coordinate system of the object and the vector that connects the camera position to the origin of the object.

FIG. 7: Provides a graphical explanation of object rotation.

### DETAILED DESCRIPTION

The know-how described in the patent application focus on three distinct operations: viewpoint orientation control, viewpoint navigation and object rotation.

a. Viewpoint Orientation Control

The goal is to be able to control viewpoint orientation in a continuous manner. In theory, an input device with three continuous degrees of freedom (such as a 2D mouse with a scrollbar) provides enough degrees of freedom to rotate the viewpoint around 3 axes (for example, Scroll movements could correspond to pitch, DimensionX movements could correspond to roll, and DimensionY movements could correspond to yaw). Yet the solution to this problem cannot be so simple, as indicated by the fact that no commercial solution uses anything similar to it.

The key problem is that humans have a natural sense of what it means to be in a horizontal position, i.e. the human brain is capable of automatically handling the horizontal state of the real or VR world as a special state—therefore, any display with viewpoint orientation control is expected to snap back to horizontal whenever the user returns to that position. When using a head-mounted display with head tracking, this poses no challenge, as there is no conflict between the user's vestibular sense and the projected image (both the user's brain and the display “know” when the viewing orientation is horizontal). On the other hand, when there is no common horizontal reference between the user's head and the display (or even simply between the user's head and the external control device), then the horizontal position of the space that is displayed is different from the horizontal plane of the head, which leads to dizziness, difficulty in navigation, and an overall deterioration of system usability. In such cases, users are accustomed to automatically turning their head by a certain degree, until the displayed image appears as horizontal (this is typical case when the display is in the user's hands or on a table, as in the case of a television set).

To replace the need for automatic head movements, one possibility is to provide users with a continuous input actuator (such as a knob) to turn back the horizon of displayed image to horizontal (this could be referred to as the “horizontalizer” knob). However, such a solution would negatively affect the usability of the system, as users would grow tired of having to turn the knob all the time, whereas in normal cases the brain would perform image correction automatically, by telling the head to change orientation. Therefore, the goal is to create an automated version of the “horizontalizer” knob.

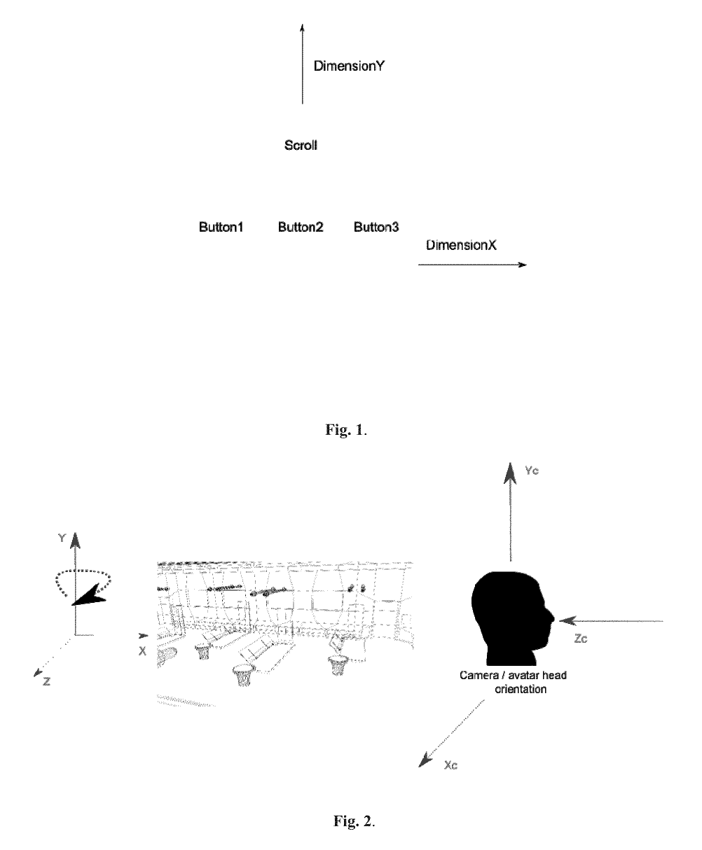

The solution that is typically used today (referred to as the passive cognitive solution) is shown in FIG. 2. The passive cognitive solution consists of fixing the axis of rotation around the camera view (which would in the normal case happen around axis Yc) to axis Y of the 3D space. This solves the original problem by making it impossible to occur: as yaw rotations always take place around the globally vertical axis, there is no way that the view can move away from horizontal (when the user's head is horizontal). However, the solution leads to a different problem—namely, the problem that when the user is looking down, yaw rotations are confounded with roll rotations (because the Zc and Y axes will be close to each other). Therefore, this solution is not adequate when the user looks downward, for example with the intention of reading and comparing documents laid out on a horizontal surface. In such cases, the view of the documents would spin around the same global vertical axis, even though the user's intention was to keep them horizontal while comparing them from the left to the right.

Instead of the passive cognitive solution, this patent application introduces the active cognitive solution. A non-trivial function is proposed to map yaw rotations to either the Y or Yc axis depending on the context of the situation. Specifically, when the user is looking down below a certain angle (as is typical when viewing documents on a table), yaw rotations are interpreted with respect to the Yc axis. Thus, the problem of unnatural rotations, i.e. the problem of documents spinning around on the plane of the screen is averted. On the other hand, when the user turns her head back upwards, the active cognitive solution automatically pushes back the Xc axis onto the X-Z plane, so that the horizontal view cannot remain tilted away from the natural horizontal viewing direction.

b. Viewpoint Navigation

Typically two kinds of navigation modes (or a combination of the two) are used in VR solutions today:
In the first case, translation in the global X-Y-Z coordinate space follows the direction specified by the orientation of the camera (hence, one continuous input dimension or alternatively a discrete ‘throttle’ button is required besides the ability to modify the camera orientation).
In the second case, translations in the X-Y-Z coordinate space are directly controlled through the coordinate values along the global X-Y-Z axes and are independent of the orientation of the camera (hence, the user is free to look around the space while moving in a direction that is independent of the camera rotation).
   In both cases, it is extremely difficult to orbit around a pre-determined focus point, especially if the radius of the orbit path is required to be fixed. This patent application proposes to add a functionality to spatial operating systems allowing users to orbit around an object (for example, a small virtual ball) while maintaining a constant view of it and at the same time keeping a fixed distance from it.

The Novelties of the Present Invention in Terms of Viewpoint Navigation:

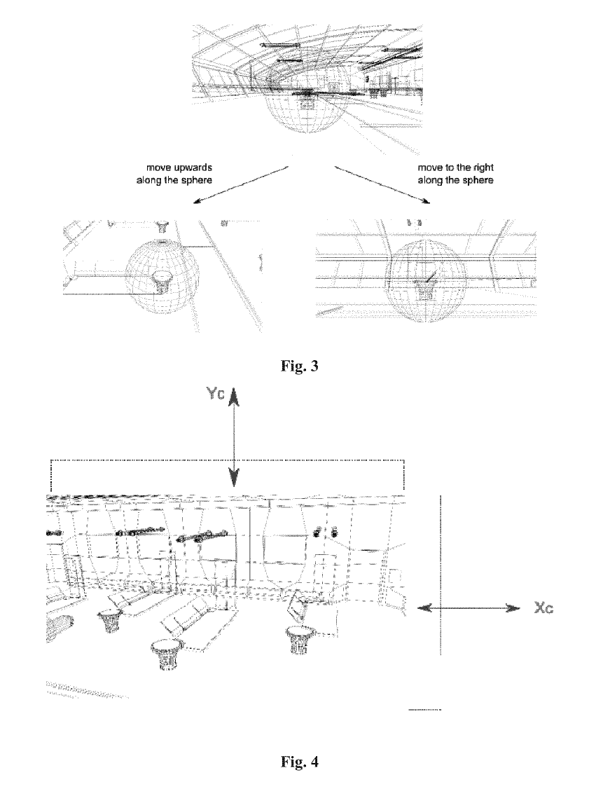

Novelty 1—the spherical orbit: When the user focuses on an object and pushes Button1, the dimensions DimensionX and DimensionY of the input device are no longer associated with rotation movements, but rather with a displacement along the latitude and longitude of a sphere that surrounds the object with radius R. The radius can be modified using the Scroll (FIG. 3).

Novelty 2—hovering: When the user presses Button2, the orientation Zc (as defined in FIG. 2) becomes fixed, and DimensionX and DimensionY of the input device control a displacement along axes Xc and Yc (FIG. 4).

Novelty 3—navigation: When the user presses and holds down Button3, the Scroll can be used to move forward or backward along axis Zc (as defined in FIG. 2). Normally, the velocity of the movement is directly proportional to the distance from the object that is at the center of the screen, based on any kind of linear or non-linear correspondence (FIG. 5). When a second button (Button2, after Button3) is pushed down as well, its movements control the velocity of the movement.

c. Object Manipulation

In two dimensional computing interfaces, contextual information such as the direction of the user's direction of gaze rarely make a difference. Whenever users move objects on the screen (such as drag-and-drop files), the movement of the objects is constrained to the 2D plane, and the direction from which the movement is viewed (i.e., the user's gaze) does not matter.

In contrast, moving objects in 3D entails moving them along a third (depth) dimension as well, and the user's viewpoint matters a great deal. For example, a bad viewing angle can make it impossible to tell whether the face of an object is directly in line with the surface to which it is to be attached. However, finding a suitable viewpoint and viewing angle is often extremely difficult.

Object Translation

The present invention proposes to constrain the movements of objects to a single, default 2-dimensional plane at any given time, but at the same time to vary the default plane depending on the viewing angle. Specifically, the following contextual information can be used to select the optimal default plane:
The user's current vantage point on the object (as described earlier, CogiNav always focuses on the object at the center of the screen)
The relationship of that vantage point to the global coordinate system
The relationship of that vantage point to the local coordinate system of the object

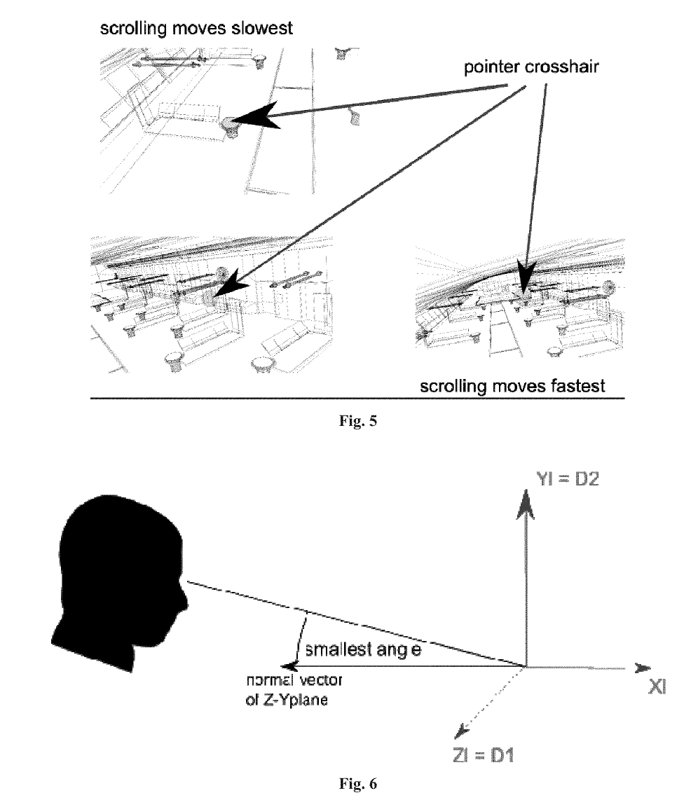

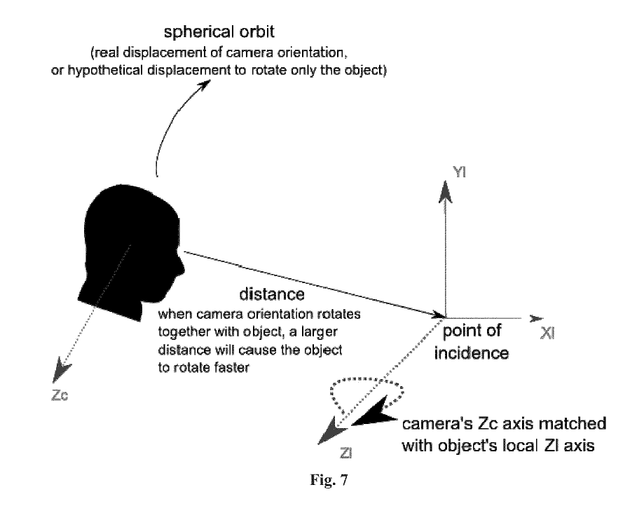

The key strategy behind CogiNav for object movement is to always move the object in the plane whose normal vector is closest (in angular terms) to the vector that links the camera position to the origin of the object's local coordinate system. This plane is referred to as the default plane, as shown in FIG. 6. Of course, it is assumed that the local coordinate system of the object is defined in reasonable terms—for example, that two axes of a sheet of paper would be parallel with the edges of the sheet. The main assertion is that defining object movements in this way comes naturally to users. For example, when sliding a sheet of paper across a table, it is natural to view the sheet of paper from above, whereas if the goal is to lift the sheet of paper off of the table, it is natural to view it from the side of the table.

One key detail that is necessary to implement this strategy is the question of how to map the axes of the input device (DimensionX and DimensionY) onto the default plane. The key to solving this problem is to find the minimal rotation suitable for superimposing the DimensionX-DimensionY coordinate system onto the coordinate system of the default plane. In other words, if DimensionX is closer to D1 than to D2, then Dimension X will control movement along the D1 axis.

Object Rotation

The present invention proposes to perform rotations of objects around their local axes based on navigation in the spatial orbit mode described earlier.

Object rotation is implemented through the following steps (FIG. 7):
1. A matching is performed between the camera's local coordinate system and the object's local coordinate system. This is naturally performed by humans, for example it is common that crane operators manipulate a 3-dimensional input device in one coordinate system while the tip of the crane is moving in a different, rotated coordinate system. It is also well defined in computational terms: the smallest rotation is to be found that converts between the two coordinate systems.
2. Once the matching is complete, rotations along the spherical orbit in terms of the camera's local coordinate system can be automatically mapped onto the rotations of the object. By projecting the user's (camera's) coordinate system onto the coordinate system of the object, the method is a truly cognitive solution that mirror's the natural capability of humans to translate between 3D coordinate systems. There are two alternative ways to implement this step:
   a. The object is rotated based on spherical orbit operations performed on the input device, but the camera's orientation remains fixed (in this case, the object will be rotated towards or away from the camera's orientation)
   b. The object is rotated together with the camera as the camera's orientation changes during spherical orbit operations. This means that for each angular unit travelled along the spherical orbit, the object is rotated around its corresponding local axis with a proportional angular unit. The angular velocity of the object may be comparatively increased when the distance from the camera position and the object is relatively large—otherwise the user would have to perform unnecessarily large orbit movements to rotate the object by a small amount (in terms of perception).

1. A method for representing functional behaviors relevant to navigation in a computer generated or computer augmented spatial environment, as well as functional behaviors relevant to the translation, rotation and position-relative circumnavigation of 2D and 3D object representations within said computer generated or computer augmented spatial environment; using a minimum of one computing device, one display device and one input device; characterized by the steps of:
a. displaying a 3-dimensional space using said display device, containing objects being represented to users together with indication of position, viewpoint orientation and target of view comprising:
(i) a globally defined 3-dimensional global coordinate system X-Y-C;
(ii) a globally defined camera position Cx, Cy, Cz;
(iii) a locally defined 3-dimensional camera coordinate system Xc-Yc-Zc determining viewpoint orientation;
(iv) a viewing direction −Zc specifying forward-looking component of said camera coordinate system;
(v) a globally defined target of view position Ox, Oy, Oz (i.e. the object being viewed);
(vi) a locally defined 3-dimensional object-centric coordinate system Xo-Yo-Zo determining orientation of said object at target of view within said 3-dimensional global coordinate system;
(vii) a 2-dimensional main subspace of said object-centric coordinate system with axis pairs denoted by S1-S2 corresponding to any one of axis pairs Xo-Yo, Xo-Zo or Yo-Zo depending on whether angle is smallest between said viewing direction (Zc) and either +/−Zo, +/−Yo or +/−Xo, respectively;
b. using a set of functions defining the relationship between input from:
i. said input device
ii. said camera coordinate system and its relationship to said global coordinate system
iii. said camera position and its distance to said target of view position
iv. said viewing direction and its relationship to said global coordinate system
v. said viewing direction and its relationship to said object-centric coordinate system and said main subspace of object-centric coordinate system
generating output to the transformation of said camera viewpoint, displayed on said display device.
c. using a set of functions defining the relationship between input from:
i. said input device
ii. said camera coordinate system and its relationship to said global coordinate system
iii. said camera position and its distance to said target of view position
iv. said viewing direction and its relationship to said global coordinate system
v. said viewing direction and its relationship to said object-centric coordinate system and said main subspace of object-centric coordinate system
and outpu t to the transformation of said object position, said object-centric coordinate system and said main subspace of object-centric coordinate system, displayed on said display device.

2. The method as claimed in claim 1, with the specification, that the functions defined in steps (b) and (c) are represented using a numerical method, whereby the computing device uses data structures consisting only of numbers, without any need to analytical formulae.

3. The method as claimed in claim 2, with the specification that the numerical method is the bi-linear TP-model transformation, defined as follows: The bi-linear tensor product model (TP model) representing any kind of multivariate, continuous function in the form of an arbitrarily accurate parametric approximation. The parametric form used by the TP model being expressed using the following formula:
$$Y = S {n ∈ N}_{} {w}_{n} ( {x}_{n} )$$
here, to store the representation of the functions and apply them according to steps (b) and (c) specifying only the core tensor (S) and the set of weighting matrices (a discretized variant of the weighting functions w, together with the discretization grid) to re-construct the output values (y) corresponding to a specific input (x) using the multivariate tensor product.

4. The method as claimed in claim 1, with the specification that the functions defined in steps (b) are “active cognitive functions” that is functions performing mapping between input from said input device and viewpoint orientation comprising:
a. a non-linear relationship describing one-to-one matching of locally defined camera yaw rotation axis (with camera yaw rotations being controlled through input device) to either vertical axis of rotation (Y) of said global coordinate system, or vertical axis of rotation (Yc) of said locally defined camera coordinate system, or a combination thereof; the non-linear relationship being dependent on the instantaneous relationship between said locally defined camera coordinate system and said global coordinate system; and
b. a “snap-to-horizontal functionality” performing a camera rotation to force the rightward-looking axis (Xc) of said locally defined camera coordinate system onto X-Z plane of said global coordinate system whenever said viewing direction axis (Zc) is sufficiently close to perpendicular to said global vertical axis (Y);

5. The method as claimed in claim 1, with the specification that the functions defined in step (b) are a “viewpoint navigation functionality” comprising:
a. an input device comprising means for input of at least 2 discrete events (Button1, Button2) and at least 2 continuous input dimensions (DimensionX, DimensionY)
b. an object-centric distance-dependent “swimming navigation mode” enabling objects to be approached through input from input device, at a speed proportional to the instantaneous distance from the object, with said instantaneous distance being defined as distance from point (Cx, Cy, Cz) to point (Ox, Oy, Oz);
c. an object-centric “spherical orbit navigation mode” around said object at target of view, preserving said distance between said object and said camera position, and preserving said object as target of view through continuous input from DimensionX and DimensionY following switching to spherical orbit mode through clicking of Button1; and
d. an object-centric “hovering navigation mode” in front of said object at target of view, preserving orientation with respect to said main subspace of object centric coordinate system of said object at target of view, allowing movement in parallel to plane defining said main subspace through continuous input from DimensionX and DimensionY following switching to spherical orbit mode through consecutive clicking of Button2

6. The method as claimed in claim 1, with the specification that the functions defined in step (c) are an “object manipulation functionality” comprising:
a. an input device comprising means for input of at least 1 discrete event (Button1) and at least 2 continuous input dimensions (DimensionX, DimensionY)
b. an “object translation” functionality on plane defined by said main subspace of object centric coordinate system of said object at target of view, through continuous input from DimensionX and DimensionY following selection of object at target of view through clicking and holding down of Button1;
c. an “object rotation” functionality rotating said object at target of view around one axis S of plane defined by said main subspace of object centric coordinate system of object at target of view, with axis S corresponding either to said axis S1 or S2 depending on whether continuous input from DimensionX or DimensionY is changing more rapidly through time, and depending on whether the global axis (X, Y or Z) corresponding to that continuous input dimension DimensionX or DimensionY has the smaller angle to S1 or S2; with said object rotation occurring in conjunction with spherical orbit navigation around said object;

7. The method as claimed in claim 1, wherein said computing, display and input devices comprise a desktop computer with monitor and mouse or external input interface, with said mouse or external input interface comprised of at least 3 buttons and 3 continuous input dimensions.

8. The method as claimed in claim 1, wherein said computing, display and input devices comprise a mobile computing device with touchscreen and/or external input interface, with said touchscreen or external input interface comprise at least 3 buttons and 3 continuous input dimensions.

9. The method as claimed in claim 1, wherein said computing, display and input devices comprise a mobile computing device mounted into a 3D headset (also called head mounted display: HMD) with separate controller device used as input device, with input controller device comprised of at least 3 buttons and 3 continuous input dimensions.

10. The method as claimed in claim 1, wherein said computing, display and input devices comprise a VR or AR 3D headset device with its own built-in computing unit using a separate controller device as input device or potentially using information recorded by the camera or other sensor as input data, with input comprised of at least 3 discrete and 3 continuous input dimensions.

11. The method as claimed in claim 1, wherein said computing, display and input devices comprise a combination of any of said devices which are communicating with each other via remote communication channels.
